(19) United States
(12) Patent Application Publication
(10) Pub. No.: US 2014/0254172 A1
(43) Pub. Date: Sep. 11, 2014

(54) LENS AND LED PACKAGE HAVING THE SAME

(71) Applicant: HON HAI PRECISION INDUSTRY CO., LTD., New Taipei (TW)

(72) Inventor: LI-YING WANG HE, Tu-Cheng (TW)

(21) Appl. No.: 13/903,977

(22) Filed: May 28, 2013

(30) Foreign Application Priority Data
Mar. 5, 2013 (TW) 102107560

(51) Int. Cl. F21V 5/04; F21K 99/00

(52) U.S. Cl. CPC F21V 5/046; F21K 9/50
USPC 362/311.02; 362/335

(57) ABSTRACT

A lens adjusts light emitted from a light source that emits the light in upward directions whereby light intensity of the adjusted light at a lateral side of the light source is increased. The lens includes a bottom surface and a top surface extending from an edge of the bottom surface. A first cavity recesses upwardly from the bottom surface for receiving a light source therein. An inner surface of the first cavity acts as a light inputting surface. A first dispersing portion protrudes downwardly from a top end of the light inputting surface. The light inputting surface collects light from the light source, the first dispersing portion disperses part of light from the light inputting surface and transmits the light to lateral sides of the light inputting surface and lateral sides of the top surface to illuminate.

### BACKGROUND

1. Technical Field

The disclosure relates to a light emitting diode (LED) package having an LED chip and a lens which can increase the intensity of light emitted from the LED package in lateral directions whereby the LED package has a wider range of illumination.

2. Description of Related Art

LEDs have many beneficial characteristics, including low electrical power consumption, low heat generation, long lifetime, small volume, good impact resistance, fast response and excellent stability. These characteristics have enabled LEDs to be widely used as a light source in electrical appliances and electronic devices.

A conventional LED generally generates a smooth round light field with a radiation angle of 120 degrees (i.e. ±60 degrees). The light emitted from the LED is mainly concentrated at a center thereof. The light at a periphery of the LED is relatively poor and typically cannot be used to illuminate. Therefore the LED cannot be used in a lamp which requires a wide illumination range, for example, an explosion-proof lamp (which may be fitted to a miner's safety helmet) or a gas station canopy lamp.

What is needed, therefore, is an improved LED package which overcomes the above described shortcomings.

### BRIEF DESCRIPTION OF THE DRAWINGS

FIG. 1 is a cross-section view of an LED package according to an exemplary embodiment of the present disclosure.

FIG. 2 is an isometric view of a lens of the LED package of FIG. 1.

FIG. 3 is similar to the FIG. 2 but shown from another aspect.

FIG. 4 is a cross-section view of the lens of FIG. 2, taken along IV-IV line thereof.

### DETAILED DESCRIPTION

An embodiment of an LED package in accordance with the present disclosure will now be described in detail below and with reference to the drawings.

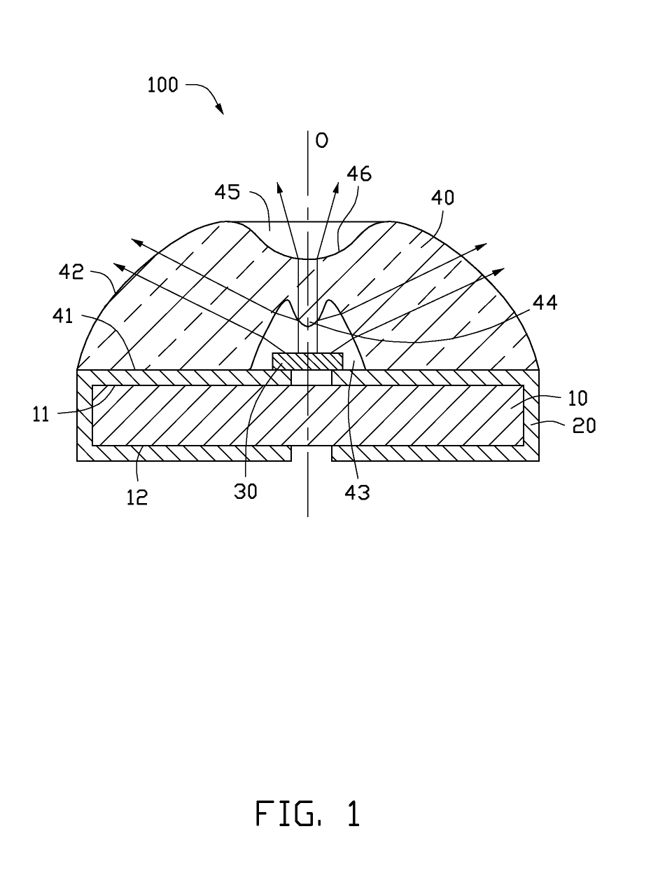

Referring to FIG. 1, an LED package 100 in accordance with an exemplary embodiment of the disclosure includes a base 10, electrodes 20 formed on the base 10, an LED chip 30 electrically connecting the electrodes 20, and a lens 40 covering the LED chip 30.

The base 10 is electrically insulating and has good heat dissipation performance. The base 10 includes a top surface 11 and a bottom surface 12 opposite to the top surface 11. In this embodiment, the base 10 is sapphire and has a rectangular cross section. Two electrodes 20 are spaced from each other and respectively enclosing opposite sides of the base 10 therein. Each electrode 20 has a U-shaped configuration and extends from the top surface 11 to the bottom surface 12. The LED chip 30 is arranged on a center of the base 10, opposite ends of of the LED chip 30 electrically contact the electrodes 20, respectively.

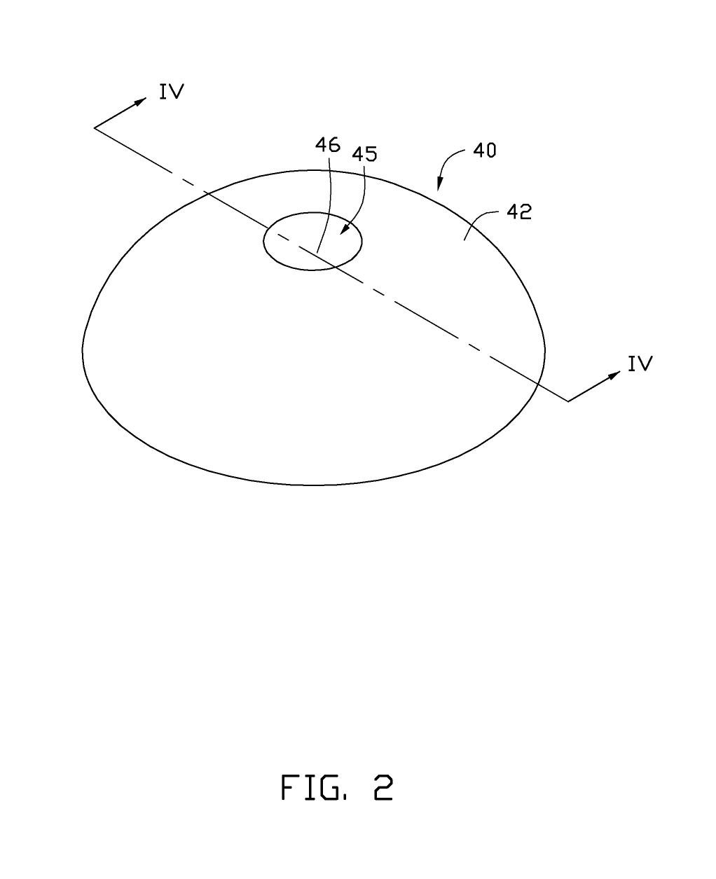

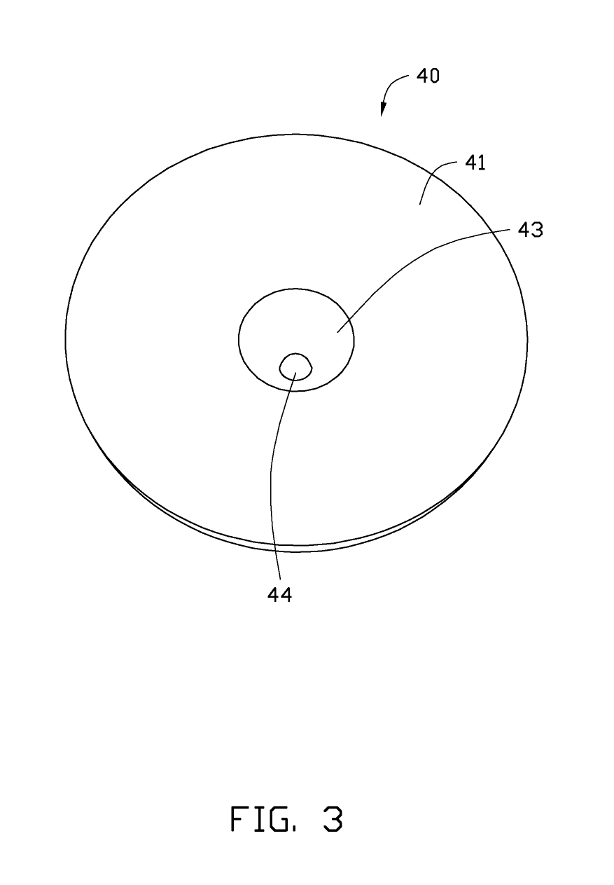

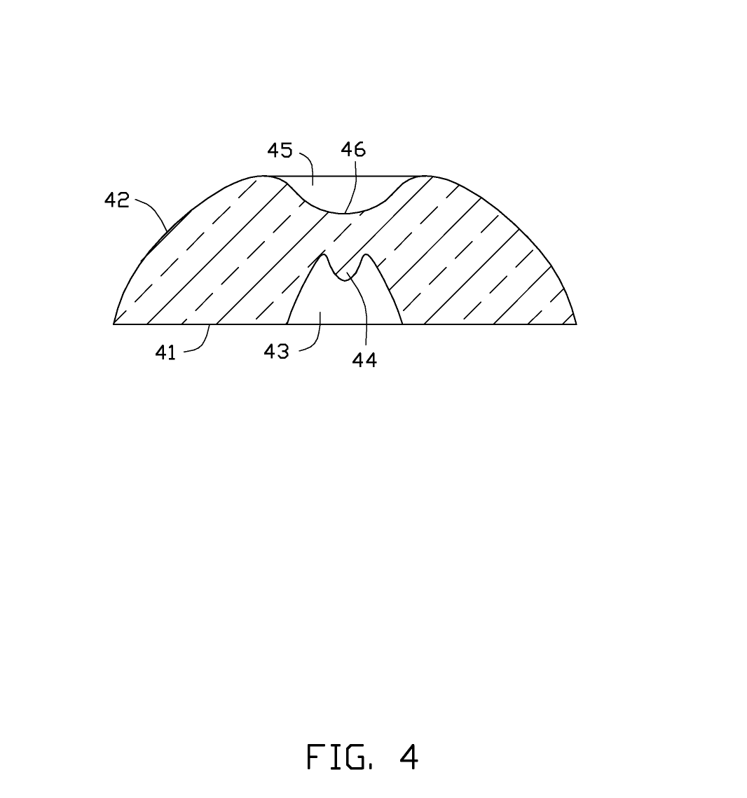

Referring to FIGS. 2-4, the lens 40 is formed on the electrodes 20 and encapsulates the LED chip 30 therein. Each lens 40 is made of material with high light transmittance, for example, glass, PMMA (polymethylmethacrylate) or PC (polycarbonate). The lens 40 is hemispheric and has an 0-0 light axis superposition with a light axis of the LED chip 30. Light emitted from the LED chip 30 travels through the lens 40 to emit. The lens 40 includes a bottom surface 41 and a top surface 42 protruding from an edge of the bottom surface 41.

The bottom surface 41 is plane and mounted on top sides of the electrodes 20. A first cavity 43 recesses upwardly from a central portion of the bottom surface 41 of the lens 40 and is oriented towards a central portion of the top surface 42. The LED chip 30 is received in the first cavity 43. An inner surface of the first cavity 43 acts as a light inputting surface of the lens 40. Light emitted from the LED chip 30 radiates into the lens 40 from the inner surface of the first cavity 43. The first cavity 43 is centrosymmetric relative to the 0-0 light axis. A first dispersing portion 44 protrudes downwardly from a top end of the first cavity 43 to disperse light arriving thereto. The first dispersing portion 44 has an inverted domical shaped configuration. A diameter of the first dispersing portion 44 increases from bottom to top. The first cavity 43 has an M-shaped cross section and the inner surface thereof is smooth.

The top surface 42 is convex and acts as a light outputting surface of the lens 40. A second cavity 45 recesses downwardly from a central of the top surface 42. The first cavity 43 and the second cavity 45 are oriented towards each other and aligned with each other. An inner surface of the second cavity 45 is a smooth and arc-shaped surface. The inner surface of the second cavity 45 acts as a second dispersing portion 46 to disperse light arriving thereto.

During operation of the LED package 100, light emitted from the LED chip 30 travels into the lens 40 via the inner surface of the first cavity 43. A part of such incident light transmits directly to lateral sides of the inner surface of the first cavity 43 and lateral sides of the top surface 42 to illuminate. Another part of the incident light transmits directly to the first dispersing portion 44. A part of light incident on the first dispersing portion 44 is dispersed by the first dispersing portion 44 and transmits to the lateral sides of the inner surface of the first cavity 43 and the lateral sides of the top surface 42 to illuminate. Another part of the light incident on the first dispersing portion 44 travels through the first dispersing portion 44 and arrives to the second dispersing portion 46 and is dispersed by the second dispersing portion 46 to transmit to the lateral sides of the inner surface of the first cavity 43 and the lateral sides of the top surface 42 to illuminate. Thus overall, the LED package 100 has a radiation angle of more than 120 degrees as measured from the center of the base 10.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lens for adjusting light emitted from a light source that emits the light in upward directions whereby light intensity of the adjusted light at a lateral side of the light source is increased, the lens comprising:
a bottom surface, a first cavity recessing upwardly from the bottom surface for receiving a light source therein, an inner surface of first cavity acting as the light inputting surface, and a first dispersing portion protruding downwardly from a top end of the light inputting surface; and
a top surface extending from an edge of the bottom surface;
wherein the light inputting surface collects light from the light source, the first dispersing portion disperses part of light from the light inputting surface and transmits the light to lateral sides of the light inputting surface and lateral sides of the top surface to illuminate.

2. The lens of claim 1, wherein the lens is hemispheric.

3. The lens of claim 1, wherein the bottom surface is plane and the first cavity is formed on a central portion thereof.

4. The lens of claim 3, wherein the first cavity has an M-shaped cross section.

5. The lens of claim 3, wherein the first dispersing portion has an inverted domical shaped configuration and a diameter thereof increases from bottom to top.

6. The lens of claim 1, wherein a second cavity extends downwardly from the top surface and aligned with the first cavity, an inner surface of the second cavity acts as a second dispersing portion of the lens to disperse light traveling through the first dispersing portion and arriving thereto to the lateral sides of the light inputting surface and the lateral sides of the top surface to illuminate.

7. The lens of claim 6, wherein the top surface is convex, and the second cavity recesses downwardly from a central of the top surface.

8. A light emitting diode (LED) package comprising:
a base;
an LED chip mounted on the base; and
a lens covering the LED chips and engaging with the base, the lens comprising:
a bottom surface, a first cavity recessing upwardly from the bottom surface for receiving a light source therein, an inner surface of first cavity acting as the light inputting surface, and a first dispersing portion protruding downwardly from a top end of the light inputting surface; and
a top surface extending from an edge of the bottom surface;
wherein the light inputting surface collects light from the light source, the first dispersing portion disperses part of light from the light inputting surface and transmits the light to lateral sides of the light inputting surface and lateral sides of the top surface to illuminate.

9. The LED lamp of claim 8, wherein the lens is hemispheric and has a light axis superposition with a light axis of the LED chip.

10. The LED lamp of claim 8, wherein two electrodes are formed on the base and the LED chip electrically connects the electrodes.

11. The LED lamp of claim 10, wherein the bottom surface is formed on the electrodes and the first cavity is formed on a central portion of the bottom surface.

12. The LED lamp of claim 11, wherein the first cavity has an M-shaped cross section.

13. The LED lamp of claim 11, wherein the first dispersing portion has an inverted domical shaped configuration and a diameter thereof increases from bottom to top.

14. The LED lamp of claim 8, wherein a second cavity extends downwardly from the top surface and aligned with the first cavity, an inner surface of the second cavity acts as a second dispersing portion of the lens to disperse light traveling through the first dispersing portion and arriving thereto to the lateral sides of the light inputting surface and the lateral sides of the top surface to illuminate.

15. The LED lamp of claim 14, wherein the top surface is convex, and the second cavity recesses downwardly from a central of the top surface.
